(19) United States
(12) Patent Application Publication
(10) Pub. No.: US 2007/0239548 A1
(43) Pub. Date: Oct. 11, 2007

(54) Method and system for determination of portioned fees for a multiplicity of entities acquiring under a single invoice

(76) Inventor: Catherine M. Sears, Northport, NY (US)

Correspondence Address: Mitchell A. Stein, Esq.;STEIN LAW, P.C., Suite 4, 24 Woodbine Avenue, Northport, NY, 11768, US

(21) Appl. No.: 11/399,853

(22) Filed: Apr. 8, 2006

(51) Int. Cl. G06Q 30/00; G06Q 40/00; H04M 15/00

(52) U.S. Cl. 705/15; 705/40; 705/34

(57) ABSTRACT

A method and system for determining portioned fees to paid by each of a multiplicity of entities “1−n” acquiring a number of items “1−x” presented under a single invoice having a CPU for determining calculations and receiving information relative to each of “1−n” and “1−x” for each of the entities; a display for displaying the items and fees for each of said entities; an information storage and retrieval system for storing for each of the number of entities “1−n” and items “1−x,” the cost for each item, tax to be applied for each item, the tip to be applied for each item, and summing for each item as well as the total for all entities; review of the invoice against the sum of all entities; and comparison for comparing the invoice against the sum. The method and system is utilized for food available to be purchased by way of a menu in a restaurant and items available from a store. The system also includes a method for determining portioned fees to paid by each of a multiplicity of entities “1−n” acquiring a number of items “1−x” presented under a single invoice, having an invoice total to one or more of the entities; one of the entities “1−n” enters one of the items of “1−x” by description; the one of the entities enters the cost of the item; the of the entities enters the tax and/or tip on the item; the are repeated until “n” is reached; and upon reaching “n” the sum is displayed and verified against the invoice.

### FIELD OF THE INVENTION

The present invention relates to the field of determination of portions of invoices for people who purchase in a group where each wishes to pay for, with or without tipping, the portion purchased, and more particularly to the instance wherein multiplicity of people wish to share a meal abroad but “pay Dutch” style where each only pays and tips for that which they actually consumed.

### BACKGROUND OF THE INVENTION

The instant invention relates to a method and system wherein logic is provided, calculation is determined, and the individual is actually aware of each item that is purchased and pays for the same, where the sum of all such choices is ensured to equal (with or without tip) the total invoice amount and each person is assured that each does not overpay for that which was delivered. Thus, the method and system is utilizable for meals abroad, as well as for any and all purchases performed at any and all locations wherein the invoice (or bill) is the sum of all the acquisitions, but the individual wishes only to pay the portion that that the individual actually received.

Applicant has found nothing even remotely similar to the method and system set forth herein in prior showings by others. For example, U.S. Pat. No. 6,886,685 shows a stationery article for carrying a self-stick note paid, U.S. Pat. No. 6,409,357 show an illuminated billfold, D420,382 shows simply a billfold with a calculator, but certainly not the method and system set forth herein, nor the means for doing the same. Other cardholder devices, all for reasons unrelated to the method and system herein, include U.S. Pat. No. 5,920,736, U.S. Pat. No. 5,878,285, U.S. Pat. No. 5,775,398, U.S. Pat. Nos. 5,734,929, 5,694,620, U.S. Pat. No. 5,617,982, U.S. Pat. No. 5,513,117, U.S. Pat. No. 5,501,383, U.S. Pat. No. 5,431,207, U.S. Pat. No. 4,889,236, U.S. Pat. No. 4,338,734, and U.S. Pat. No. D263,966.

It should be appreciated that there is a real and present change in the “generosity” of those who simply “pick up the tab” for an entire table at a restaurant or purchase items for others without regard for specific purchases by each. While people congregate together for social and other occasions, the money each person has is typically kept “close to the vest” of the individual, rather than shared amongst the group. Each individual generally wishes to pay for that which that individual has acquired.

Likewise, while the situation is perhaps more generally applicable to a meal, it is just as applicable to any other purchase wherein at least one person is involved but the invoice or bill accumulates them all. The individual wishes to pay for his or her own portion, not a simple mathematical 50/50 or some other generous person show simply pays the entire bill. Even in the latter, the division between the at least one person will likely occur, and the accuracy of the same becomes of paramount importance as money is involved.

Thus, it is an object of the invention to determine the acquisition of each of a multiplicity of people where there is a single invoice.

There is another object of the invention to provide the individual acquirer with the ability to determine the tip, as all acquisitions may not be equal nor all decisions to tip may not be the same.

It is a further object of the instant invention to eliminate any conflicts amongst the multiplicity of people by verification of the total against the invoice to ensure that the amounts are exact, and no conflicts occur.

Further objects will become apparent to one of ordinary skill in the art upon the understanding of the instant invention.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

A method and system for determining portioned fees to paid by each of a multiplicity of entities “1−n” acquiring a number of items “1−x” presented under a single invoice having a CPU for determining calculations and receiving information relative to each of “1−n” and “1−x” for each of the entities; a display for displaying the items and fees for each of said entities; an information storage and retrieval system for storing for each of the number of entities “1−n” and items “1−x,” the cost for each item, tax to be applied for each item, the tip to be applied for each item, and summing for each item as well as the total for all entities; review of the invoice against the sum of all entities; and comparison for comparing the invoice against the sum. The method and system is utilized for food available to be purchased by way of a menu in a restaurant and items available from a store. The system also includes a method for determining portioned fees to paid by each of a multiplicity of entities “1−n” acquiring a number of items “1−x” presented under a single invoice, having an invoice total to one or more of the entities; one of the entities “1−n” enters one of the items of “1−x” by description; the one of the entities enters the cost of the item; the of the entities enters the tax and/or tip on the item; the are repeated until “n” is reached; and upon reaching “n” the sum is displayed and verified against the invoice.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is a flow chart of the method and system of the preferred embodiment of the subject invention showing the components and various functions; and

FIG. 2 is a flow chart of the underlying logic of the method and system of the preferred embodiment of the subject invention showing the sequence of events for parsing an invoice in accordance with the desire of an individual of 1−n individuals who purchases 1−x items.

### DETAILED DESCRIPTION OF THE PREFERRED EMBODIMENTS

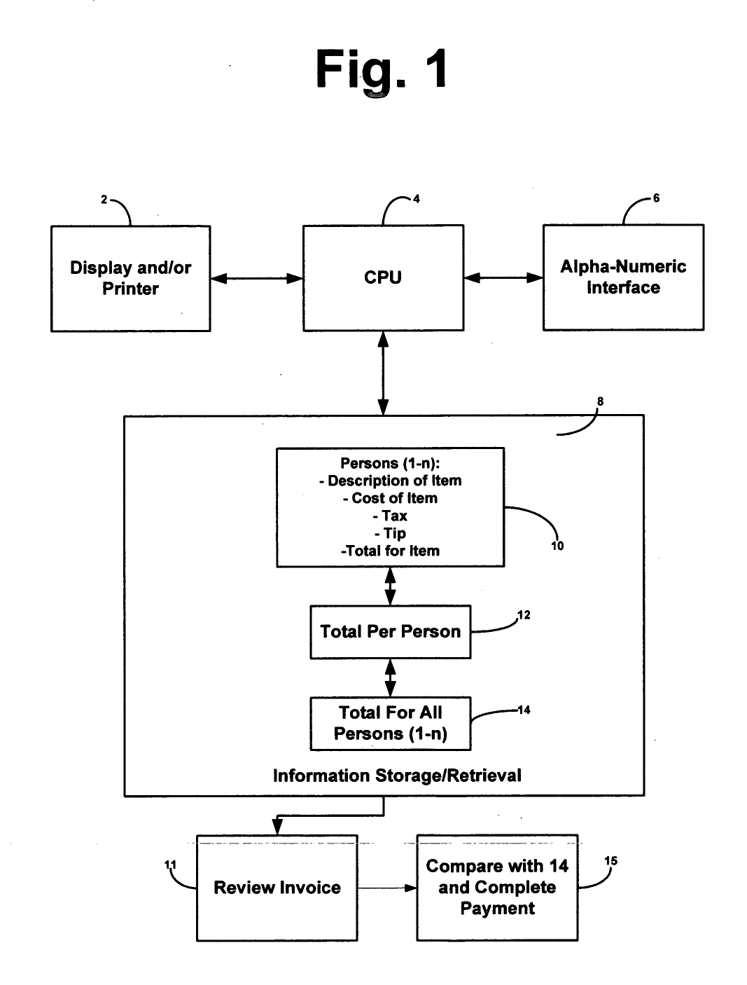

As shown in FIG. 1, a display or printer 2 is included in the device so that a multiplicity of persons may be able to view the items acquired. Display 2 is connected to CPU 4 which performs the calculations. (“CPU” means central processing unit, and can be any of those known by those of ordinary skill in the art including, without limitation, from small bit processors (like Z-80 or 8 bit devices) to full blown 32 bit processors. In terms of costs and the logic herein, even an EPROM or and E2PROM may satisfy the functions set forth herein. The CPU itself is thus selectable, depending upon the logic necessary to achieve the functions sought by the instant invention.)

In order to input and output to CPU 4, an alpha-numeric interface 5 is shown. It should be appreciated that when items are acquired generally such items include both words (“alpha”) describing the item and costs (“numeric”) for the costs of the item. Thus, the interface is necessary to provide such information.

Once the information acquired by the multiplicity of persons is known by the CPU, an information and storage device 8 is provided which integrates with CPU 4 in order to perform calculations, interface 5 to provide the user with the ability to enter information, and display 2 to shown such information. In storage 5, the individual acquisitions by each of the multiplicity of persons 1−n are stored and shown via step 10. In particular, for each of persons 1−n, the description of the item, cost, tax, tip (if any) and total for item is entered via interface 6 and stored via step 10 of storage 8. This provides the individual the ability to not only view and ensure that that which was acquired by that individual was accurate, but the cost, tax and tip (if any) are entered. For each such item, the total is shown.

It should be appreciated by one of ordinary skill in the art that FIG. 1 provides the person of 1−n the ability to determine in advance whether to acquire, since all the costing information will be provided thereby. Thus, the individual may decline the purchase if so desired.

Once each person 1−n has entered the information via step 10, then the total per person is shown via display 2 and stored via storage 8 in accordance with step 10. Of course, the total for all person is then displayed and stored via step 14.

Once this has occurred, the method and system then reviews the invoice at step 11 (which can involve the individuals 1−n), comparison with step 14 (the total for all persons 1−n) is compared, and payment can be completed via step 15. (It should be understood by one of ordinary skill in the art that “1−n” and “1−x” means one or more.)

In this manner, each individual can determine and pay for that which is acquired with confidence that no overpayment, or underpayment has occurred.

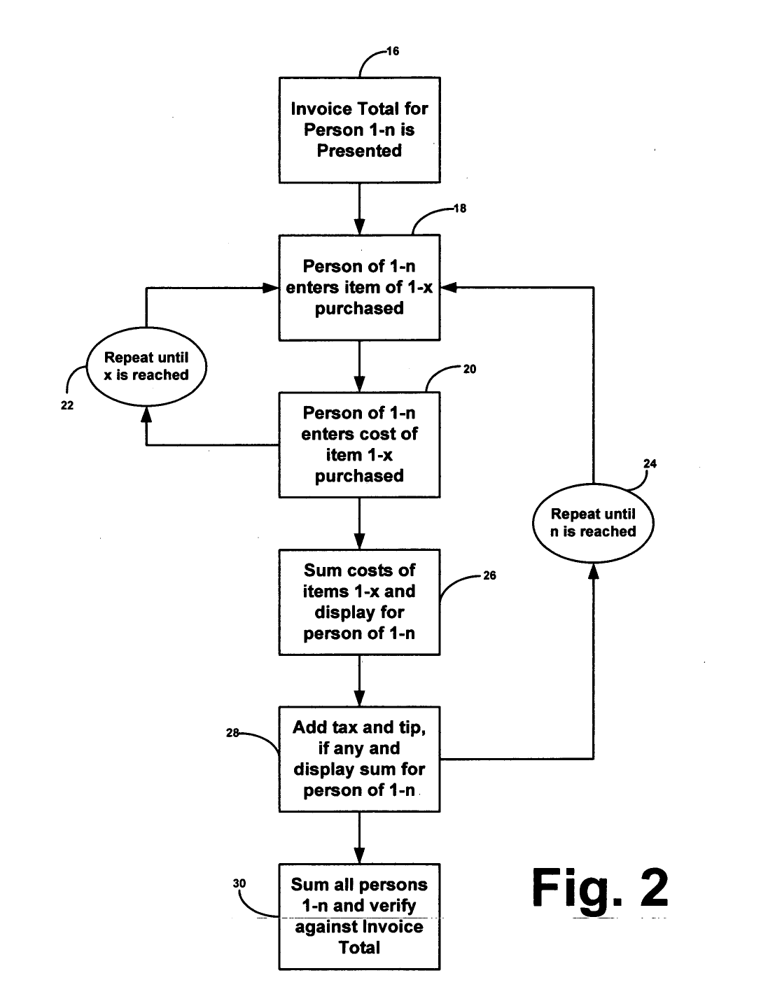

As shown in FIG. 2, at least one person (i.e., a multiplicity) procures more than one item, but does not wish to pay for anything more than that at least one person has acquired. Accordingly, upon acquisition, bill invoice 16 is provided for persons 1−n and presented. It should be understood from one of ordinary skill in the art that “person” can mean any entity, like a corporation or company, without deviation from the scope of the invention disclosed herein.

Upon presented of invoice 16, each of persons 1−n is sees the invoice, and then enters items 1−x actually acquired via step 20. Each entry requires (in reference to FIG. 1) alpha-numeric entry via interface 6, and the process per person is repeated until “x” (the total umber of items acquired by that person is reached via step 22. Upon which, the costs of the total 1−x are displayed for person “n” via step 26. Tax and tip (if any) are added to the total for person “n” via step 28. This process is repeated via step 24 until “n” is reached, at which point, the sum of all persons 1−n is presented and verified against the invoice total at step 30.

In this manner, it is thus a feature of the invention to determine the acquisitions, costs and tips for each of a multiplicity of persons can be determined, such that each pays only their proportionate share.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A system for determining portioned fees to paid by each of a multiplicity of entities “1−n” acquiring a number of items “1−x” presented under a single invoice, comprising:
(a) a CPU for determining calculations and receiving information relative to each of “1−n” and “1−x” for each of the entitites;
(b) display unit mean for displaying the items and fees for each of said entities;
(c) an information storage and retrieval system for storing for each of the number of entities “1−n” and items “1−x,” the cost for each item, tax to be applied for each item, the tip to be applied for each item, and summing for each item as well as the total for all entities;
(d) means for reviewing the invoice against the sum of all entities; and
(e) comparison means for comparing the invoice against the sum.

2. The system of claim 1, wherein the display unit includes a printer.

3. The system of claim 1, wherein the display is an LCD.

4. The system of claim 1, wherein the information and retrieval system is a mass storage computer drive.

5. The system of claim 1, wherein the means for reviewing the invoice and comparison means is performed by the CPU and an output provided.

6. The system of claim 1, wherein the number of items are selected from the group consisting of food available to be purchased by way of a menu in a restaurant and items available from a store.

7. A method for determining portioned fees to paid by each of a multiplicity of entities “1−n” acquiring a number of items “1−x” presented under a single invoice, comprising:
(a) presenting the invoice total to one or more of the entities;
(b) one of said entities “1−n” enters one of the items of “1−x” by description;
(c) said one of said entities enters the cost of said item;
(d) said one of said entities enters the tax on said item;
(e) said one of said entities optionally enters a tip;
(f) steps (b) through (e) are repeated until “n” is reached; and
(g) upon reaching “n” the sum is displayed and verified against the invoice.

8. The method of claim 7, wherein the number of items are selected from the group consisting of food available to be purchased by way of a menu in a restaurant and items available from a store.
